(19) United States
(12) Patent Application Publication
(10) Pub. No.: US 2002/0175923 A1
(43) Pub. Date: Nov. 28, 2002

(54) Method and apparatus for displaying overlapped graphical objects using depth parameters

(76) Inventors: Tsung-Wei Lin, Taipei (TW); Chih-Hsuan Liu, Taipei (TW); Shih-Yang Wang, Taipei (TW)

Correspondence Address: BIRCH STEWART KOLASCH & BIRCH, PO BOX 747, FALLS CHURCH, VA, 22040-0747, US

(21) Appl. No.: 10/153,635

(22) Filed: May 24, 2002

(30) Foreign Application Priority Data
May 24, 2001 (TW) 90112495

(51) Int. Cl. G09G 5/00

(52) U.S. Cl. 345/629

(57) ABSTRACT

A graphics processing method using depth parameters for manipulating the inter-overlapping situation between graphic objects and image objects. For each of the graphic objects, the pixels thereof are assigned to respective depth parameters by a three-dimensional transformation procedure. Each of the image objects is assigned to one constant value as its depth parameter. The rendering of the image objects and the graphic objects is performed by sequentially displaying these objects according to their depth parameters. On an overlapping region between these objects, a visible object is selected from the overlapping objects according to the depth parameters assigned to the parts of these objects corresponding to the overlapping region. The resulting image is further processed by processing surface intersections of the overlapping regions of the overlapping objects to smooth the boundary area.

### BACKGROUND OF THE INVENTION

1. Field of the Invention

The present invention relates to computer graphics technology, and particularly to a graphics processing method and apparatus for displaying overlapped graphical objects, such as computer graphic objects or image objects, by using depth parameters, which can also provide functions such as depth sorting and layered merging.

2. Description of the Prior Art

By virtue of the development of computer technology, most image or graphics data, manually designed in the past, can currently be rendered by computers. Computer graphics technology can save a huge amount of manpower and help professionals to produce images and graphics muich more easily.

However, computer graphic technology is only suitable for processing two-dimensional image objects and producing two-dimension visual effects due to the limitations of display devices and computers. When a computer graphics image comprises different computer graphic objects or image objects with several overlapping regions, it is important to determine which lines or planes of the objects are visible. A conventional algorithm for determining the visible lines or planes, called the list priority algorithm, utilizes the layered merging scheme to deal with the overlapping objects. First, the user assigns a unique depth parameter to each of the graphic objects or image objects, where the depth parameter corresponds to the z-coordinate of the corresponding object. If the graphic objects or image objects partially overlap, a display layer sequence will be generated in view of the corresponding depth parameters or z-coordinates. In the rendering procedure, these objects are rendered from bottom to top according to the display layer sequence to show the resulting image on a monitor. Using this scheme, the desired image can be rendered in proper order on the monitor.

An example of computer images processed by the conventional list priority algorithm is illustrated in FIG. 1. In FIG. 1, there are two overlapping polygons 1 and 3, each of which is assigned a unique depth parameter. In this example, the assigned depth parameter of polygon 1 is smaller than that of polygon 3, that is, polygon 1 is in a lower layer and polygon 3 is in a higher layer. Thus, as shown in FIG. 1, polygon 3 completely hides polygon 1 in the overlapping regions 5 and 7. FIG. 2 illustrates a schematic diagram illustrating another example of processing overlapping objects using the conventional list priority algorithm. In FIG. 2, the image contains a graphic object 10 and an image object 12. Since the depth parameter of graphic object 10 is larger than that of image object 12, the graphic object 10 completely hides image object 12 in an overlapping region 11.

However, the conventional layering scheme cannot deal with image or graphic objects inter-overlapping. FIG. 3 and FIG. 4 illustrate two examples of inter-overlapping objects. In FIG. 3, polygon 20 and polygon 22 are inter-overlapping, where a corner 20a of polygon 20 is visually under polygon 22 and a corner 20b of polygon 20 is visually above polygon 22. In this case, it is almost impossible to deal with the rendering of such an image by the conventional scheme since only one depth parameter is assigned to each object. In FIG. 4, the ends of polygon 24, 26 and 28 are interlaced with each other. For example, a corner 24a of polygon 24 is under polygon 26 and another corner 24b of polygon 24 is above polygon 28. The conventional scheme cannot deal with such inter-overlapping objects.

The issue of the present application is to process the display of overlapped image objects or graphic objects using depth parameters, especially for inter-overlapping objects, and to render the desired image by depth sorting and layered merging.

### SUMMARY OF THE INVENTION

Accordingly, the object of the present invention is to provide a method and apparatus of displaying inter-overlapping graphics or image objects by using depth parameters, which can accurately achieve the combination of graphic objects and image objects to obtain better 3D visual effect.

The present invention achieves the above-indicated object by providing a graphics processing method applied to a computer system having a display device. At first, a plurality of objects to be displayed on the computer system, such as graphic objects or image objects, are retrieved. Next, each object is assigned a plurality of depth parameters corresponding to a plurality of parts thereof by an assignment procedure. In the following embodiment, if the object is an image object, the depth parameter of the image object is set as one constant value. If the object is a graphic object, the pixels thereof are assigned to respective depth parameters by a three-dimensional transformation procedure. Finally, these objects are displayed on the computer system in view of the assigned depth parameters, respectively. If there is an overlapping region between two or more objects on the display device, the rendering of the overlapping region is performed by selecting one of the overlapping objects as a visible object based on the depth parameters assigned to the parts of the overlapping objects corresponding to the overlapping region. The resulting image can be further processed processing surface intersections of the overlapping regions of the overlapping objects to smooth the boundary area. Therefore, the image, including inter-overlapping objects, can be properly rendered by the method of the present invention.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) is a schematic diagram illustrating a first image example rendered by the conventional method for processing overlapping graphic objects;

FIG. 2 (Prior Art) is a schematic diagram illustrating a second image example rendered by the conventional method for processing overlapping graphics and image objects;

FIG. 3 (Prior Art) and FIG. 4 (Prior Art) are schematic diagrams illustrating two different inter-overlapping cases;

FIG. 5 is a flowchart of the graphics processing method using the depth parameters according to the embodiment of the present invention;

FIG. 6 is a schematic diagram illustrating a combined image of a graphic object and an image object rendered by the graphics processing method of the present invention;

FIG. 7 is a schematic diagram illustrating a first example of the combined image of graphic objects rendered by the graphics processing method of the present invention;

FIG. 8 is a schematic diagram illustrating a second example of the combined image of graphic objects rendered by the graphics processing method of the present invention; and

FIG. 9 is a schematic diagram illustrating a third example of the combined image of graphic objects rendered by the graphics processing method of the present invention.

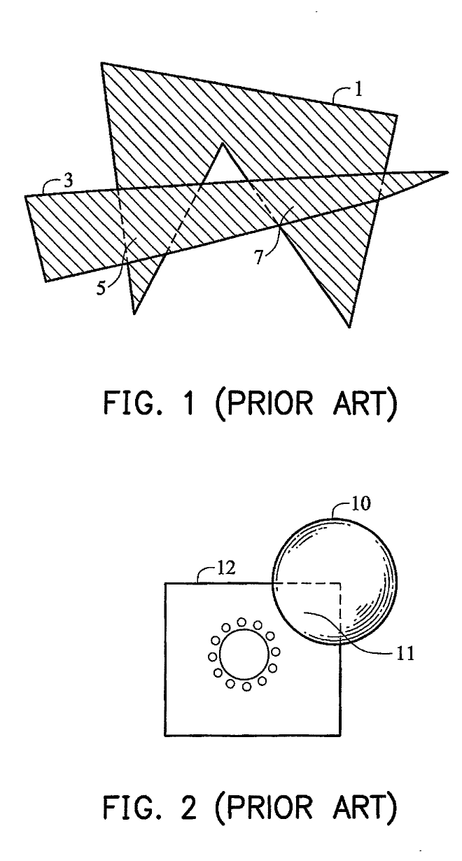

### DETAILED DESCRIPTION OF THE INVENTION

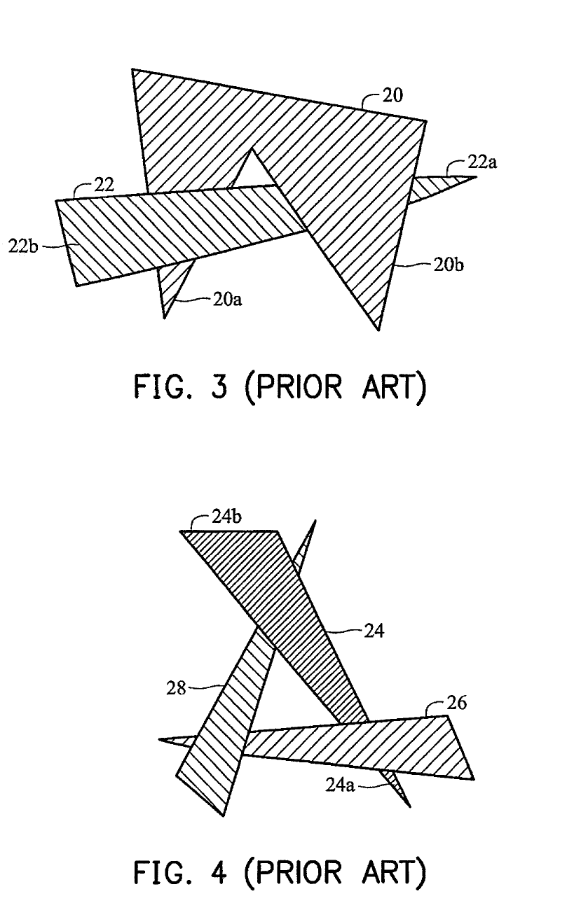

This invention discloses a graphics processing method to cope with partially overlapping graphic objects and image objects. Especially, the disclosed method deals with the inter-overlapping of these objects, as illustrated in FIG. 3 and FIG. 4, to effortlessly render the image view in proper perspective. The solution adopted in the present invention is achieved by the use of depth parameters. In the conventional technique, each of the graphic objects and the image objects is assigned a unique depth parameter, which cannot be used to properly render an image view based on the predetermined procedure when there is an inter-overlapping situation. In the present invention, each pixel or point of the graphic objects is assigned a corresponding depth parameter through an assignment procedure, such as the three-dimensional transformation procedure, to properly show an image view of overlapping objects. The preferred embodiment of the present invention is disclosed as follows accompanying the drawings. It is noted that the method steps of the present invention can be implemented by a computer program and stored on computer-readable media, such as floppy disc, CD-ROM or DVD.

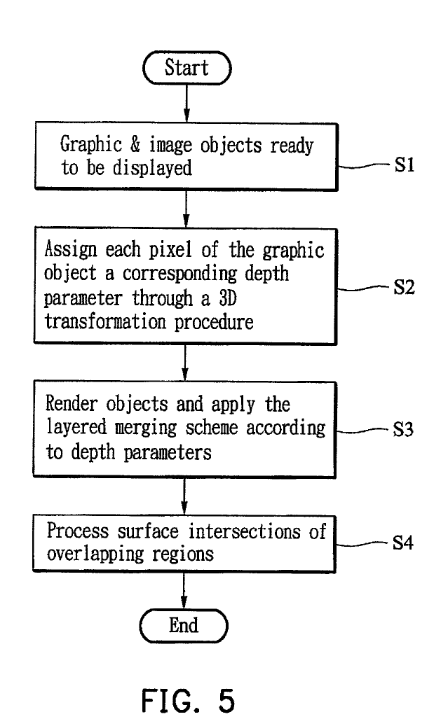

FIG. 5 is a flowchart of the graphics processing method using the depth parameters according to the embodiment of the present invention. At first, a plurality of image objects and graphic objects ready to be processed and displayed are retrieved (step S1). In the present embodiment the image object is an object of a plane image. Then, by an assignment procedure, a variety of depth parameters are assigned to each of the image objects or the graphic objects based on the parts thereof (step S2). Since the image object is a plane view, all the parts of the image object are assigned one constant value as the depth parameter. In the present embodiment, the depth parameter of the image object is set at 0. In addition, the assignment procedure can be a three-dimensional transformation procedure, which regularly determines the assigned depth parameters or z-coordinates of the pixels of the graphic object, if the processed object is a graphic object. For example, the three-dimensional transformation procedure may be the method disclosed in Taiwan Patent Publication No. 299,413. After the processing of the three-dimensional transformation procedure, the graphic object may be transformed to a 3D-beveled object, 3D-trimmed object, a 3D-trimmed wrap object or other transformed 3D objects. The 3D transformation procedure can determine the z-coordinates of pixels of a 2D object based on the attributes of the corresponding 2D object. It is noted that the use of the 3D transformation procedure as the assignment procedure is not intended to limit the scope of the present invention. For those skilled in the art, mapping functions between the parts or pixels of the graphic objects and the depth parameters can be achieved by various schemes.

After the completion of the assignment of the depth parameters to all of the image and graphic objects, the merged image of the image and graphic objects is ready to render. It is noted that the overlapping regions of these objects are processed by the layered merging scheme in view of the depth parameters thereof (step S3). In the non-overlapping regions of these objects, only one object is visible and the process of layer ordering is not necessary. However, in the overlapping regions thereof, determining which layer or object is in the upper layer is a critical issue. When the inter-overlapping situation occurs, it is easy to decide which object is in the upper layer or in the lower layer in an overlapping region in view of the depth parameters assigned to the parts of these overlapping objects corresponding to the location of the overlapping region, which can achieve the object of the present invention.

After rendering the graphic and image objects, the surface intersections of the overlapping regions are further processed to smooth the boundaries of these objects (step S4). Finally, the method of the present invention is complete.

Using the graphics processing method disclosed in the present embodiment, the inter-overlapping situation, which cannot be solved by the conventional scheme, can be properly manipulated. It is noted that it is not necessary to assign the depth parameters to all pixels of the graphical objects by 3D transformation procedure. In certain cases, partially assigning the depth parameters of these objects through the 3D transformation procedure is enough to obtain the desired perspective effect. For example, in the inter-overlapping situation shown in FIG. 3, the user can execute the default 3D transformation procedure to define the depth parameters of the pixels of polygon 20. In addition, the user can assign polygon 22 one constant value as the depth parameter. After completion of the 3D transformation procedure, the depth parameter assigned to polygon 20 is larger than that assigned to an end 22a of polygon 22 and smaller than that assigned to an end 22b of polygon 22. Thus, the image shown in FIG. 3 can be properly rendered. However, in the inter-overlapping situation shown in FIG. 4, displaying the proper image of these graphic objects requires processing all of the polygons 24, 26 and 28 through the default 3D transformation procedure.

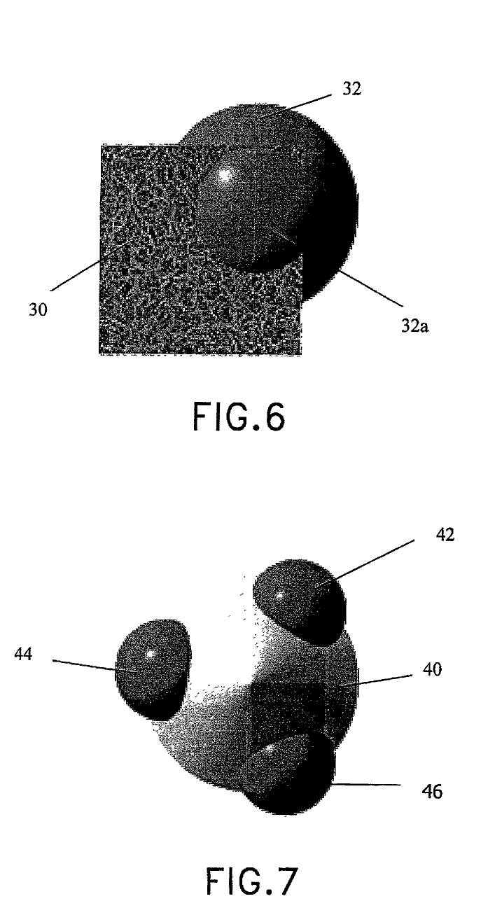

FIG. 6 is a schematic diagram illustrating a combined image of a graphic object and an image object rendered by the graphics processing method of the present invention. This combined image is similar to that shown in FIG. 2. In FIG. 6, graphic object 32 is processed by a 3D transformation procedure to generate the depth parameters (that is, the z-coordinates) assigned to the pixels thereof. In this case, the depth parameter of image object 30 is set to be 0. In addition, the parameters of the pixels of the spherical graphic object 32, except a portion of shell 32a, are set to be lower than 0. Thus, as shown in FIG. 6, the appearance of image object 30 is to insert the top of spherical graphic object 32. Thus, shell 32a hides the overlapping region in the location of the shell 32a and the image object 30 hides the overlapping region between the image object 30 and the graphic object 32 except the shell 32a. The difference between the present invention and the conventional scheme can be illustrated by comparing FIG. 2 and FIG. 6.

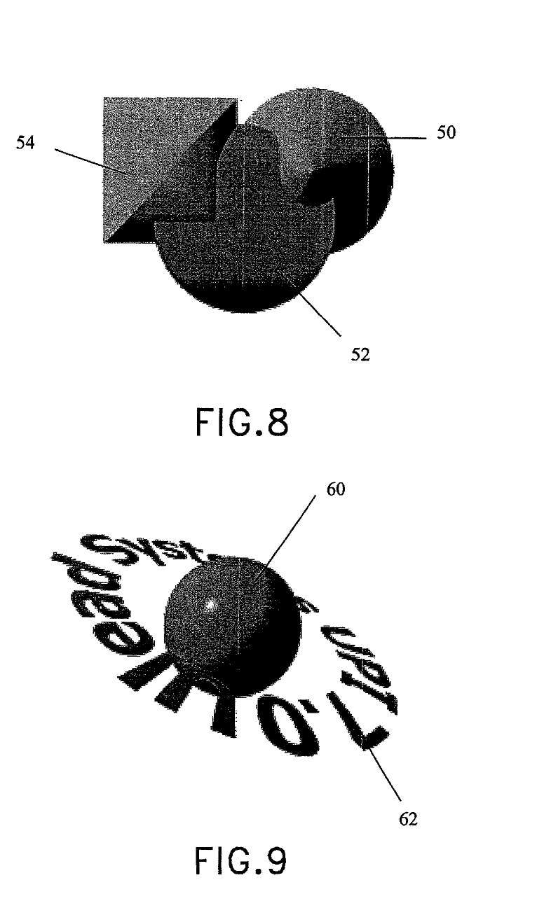

The disclosed method of the present invention does not only produce refined images differently than the conventional scheme, but also renders graphic images difficult to design in the past. FIG. 7 is a schematic diagram illustrating a first example of the combined image of graphic objects rendered by the graphics processing method of the present invention. In FIG. 7, object 40 is a three-dimensional beveled object formed by a pyramid and each of objects 42, 44 and 46 is a 3D beveled object formed by a spheroid. The image shown in FIG. 7 can be easily rendered by the graphics processing method disclosed in the embodiment. FIG. 8 is a schematic diagram illustrating a second example of the combined image of graphic objects rendered by the graphics processing method of the present invention. In FIG. 8, objects 50 and 54 are 3D beveled objects and object 52 is a 3D trimmed object, where object 52 is inserted into objects 50 and 54. FIG. 9 is a schematic diagram illustrating a third example of the combined image of graphic objects rendered by the graphics processing method of the present invention. In FIG. 9, object 60 is a 3D spheroid object and object 62 is a string wrap object formed by transforming a 2D string object. The string wrap object 62 encircles the spheroid object 60.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A graphics processing method applied to a computer system with a display device, comprising the steps of:
retrieving a plurality of objects to be displayed on the computer system;
assigning a plurality of depth parameters to a plurality of parts of two overlapping objects to be displayed by an assignment procedure; and
displaying the objects on the display device of the computer system in view of the assigned depth parameters, an overlapping region of the overlapping objects on the display device displayed by selecting one of the overlapping objects as a visible object based on the depth parameters assigned to the parts of the overlapping objects corresponding to the overlapping region.

2. The graphics processing method of claim 1, wherein the object is an image object and the parts of the image object are assigned one constant value.

3. The graphics processing method of claim 1, wherein the object is a graphic object and the assignment procedure is a three-dimensional transformation procedure for assigning the depth parameters to pixels of the graphic object.

4. The graphics processing method of claim 3, wherein the graphic object is transformed to a three-dimensional beveled object by the three-dimensional transformation procedure.

5. The graphics processing method of claim 3, wherein the graphic object is transformed to a three-dimensional trimmed object by the three-dimensional transformation procedure.

6. The graphics processing method of claim 3, wherein the graphic object is transformed to a three-dimensional trimmed wrap object by the three-dimensional transformation process.

7. The graphics processing method of claim 1, further comprising the step of:
processing surface intersections of the overlapping regions of the overlapping objects.

8. An apparatus for displaying graphics/image objects in a computer system with a display device, comprising:
means, performed by the computer, for retrieving a plurality of objects to be displayed on the computer system;
means, performed by the computer, for assigning a plurality of depth parameters to a plurality of parts of two overlapping objects to be displayed by an assignment procedure; and
means, performed by the computer, for displaying the objects on the display device of the computer system in view of the assigned depth parameters, an overlapping region of the overlapping objects on the display device displayed by selecting one of the overlapping objects as a visible object based on the depth parameters assigned to the parts of the overlapping objects corresponding to the overlapping region.

9. The apparatus of claim 8, wherein the object is an image object and the assigning means assigns one constant value to the parts of the image object.

10. The apparatus of claim 8, wherein the object is a graphic object and the assignment procedure executed by the assigning means is a three-dimensional transformation procedure for assigning the depth parameters to pixels of the graphic object.

11. A computer readable medium storing a computer program executable by a computer system with a display device to perform graphics processing method steps, the method comprising the steps of:
retrieving a plurality of objects to be displayed on the computer system;
assigning a plurality of depth parameters to a plurality of parts of two overlapping objects to be displayed by an assignment procedure; and
displaying the overlapping objects on the display device of the computer system in view of the assigned depth parameters, an overlapping region of the overlapping objects on the display device displayed by selecting one of the overlapping objects as a visible object based on the depth parameters assigned to the parts of the overlapping objects corresponding to the overlapping region.

12. The computer readable medium of claim 11, wherein the object is an image object and the parts of the image object are assigned one constant value.

13. The computer readable medium of claim 11, wherein the object is a graphic object and the assignment procedure is a three-dimensional transformation procedure for assigning the depth parameters to pixels of the graphic object.

14. The computer readable medium of claim 13, wherein the graphic object is transformed to a three-dimensional beveled object by the three-dimensional transformation procedure.

15. The computer readable medium of claim 13, wherein the graphic object is transformed to a three-dimensional trimmed object by the three-dimensional transformation procedure.

16. The computer readable medium of claim 13, wherein the graphic object is transformed to a three-dimensional trimmed wrap object by the three-dimensional transformation process.

17. The computer readable medium of claim 11, the method further comprising the step of:
processing surface intersections of the overlapping regions of the overlapping objects.
